(19) United States
(12) Patent Application Publication
(10) Pub. No.: US 2007/0000171 A1
(43) Pub. Date: Jan. 4, 2007

(54) Plant seedling pot and method for its manufacture

(75) Inventor: David N. Stearns, Canby, OR (US)

Correspondence Address: ATER WYNNE LLP, 222 SW COLUMBIA, SUITE 1800, PORTLAND, OR, 97201-6618, US

(73) Assignee: IFA Nurseries, Inc.

(21) Appl. No.: 11/171,596

(22) Filed: Jun. 29, 2005

(51) Int. Cl. A01G 9/10

(52) U.S. Cl. 47/73

(57) ABSTRACT

The invented plant seedling pot includes an elongate hollow body including a base region and a base substantially sealing the base region of the hollow body. The hollow body preferably is slightly uniformly tapered upwardly and outwardly from the base and has a nominal height and width, the ratio between which is greater than approximately 2.5:1 and preferably approximately 3:1. The interior of the hollow body is dimensioned to contain a substantial portion of a plant seedling including a root ball and an elongate trunk. A preferably regular array of plural instances of the pot preferably are molded from an organic fiber mesh including, for example, coconut fiber and a binder. The method of manufacture thus includes providing a two-part mold having one or more aligned pairs of deep narrow recesses; configuring the two parts to nest within one another; charging one or more concavities or gaps between the mold parts with a volume of slurry; curing the slurry as by drying; and releasing and ejecting the one or more cured, slimly tapered plant seedling pots from the mold.

### BACKGROUND OF THE INVENTION

This invention relates generally to the field of pots for the containment, transportation, protection, presentation and planting of tender young plant seedlings. More specifically, it concerns a pot for containing, transporting, protecting, presenting and planting seedlings, and a method for manufacturing the same.

### SUMMARY OF THE INVENTION

The invented plant seedling pot includes an elongate hollow body including a base region and a base substantially sealing the base region of the hollow body. The hollow body preferably is slightly uniformly tapered upwardly and outwardly from the base and has a nominal height and width, the ratio between which is greater than approximately 2.5:1 and preferably approximately 3:1. The interior of the hollow body is dimensioned to contain a substantial portion of a plant seedling including a root ball and an elongate trunk. A preferably regular array of pots preferably is molded from an organic fiber mesh including, for example, coconut fiber and a binder. The method of manufacture thus includes providing a two-part mold having one or more aligned pairs of deep narrow recesses; configuring the two parts to nest within one another; charging one or more concavities or gaps between the mold parts with a volume of slurry; curing the slurry as by drying; and releasing and ejecting the one or more cured, slimly tapered plant seedling pots from the mold.

### BRIEF DESCRIPTION OF THE DRAWINGS

FIG. 1 is an isometric view of the plant seedling pot, in accordance with one embodiment of the invention, with a partial cutaway view detailing its construction and with a tree seedling and root ball shown in phantom.

FIGS. 2A, 2B and 2C are a front elevation, a top plan view and a bottom plan view, respectively, of the plant seedling pot shown in FIG. 1.

FIGS. 3A-3F are isometric views illustrating various steps of the method for manufacturing the plant seedling pot, in accordance with one embodiment of the invention. Specifically, FIG. 3A illustrates the two-part mold configured with plural mating recessed-structure pairs to produce plural instances of the plant seedling pot, with the gaps between corresponding recesses of the two parts of the mold being charged with an organic fiber mesh slurry; FIG. 3B illustrates the pressing of the two parts of the mold together to compress the slurry volumes within the gaps; FIG. 3C illustrates the curing of the plural instances of the plant seedling pot; FIG. 3D illustrates the separating of the two parts of the mold to leave most or all of the plant seedling pots in the recesses within the lower part thereof; FIG. 3E illustrates the releasing/ejecting of the plural instances of the plant seedling pot from the inverted lower part of the two-part mold; and FIG. 3F illustrates the optionally required trimming of the upper rim of one instance of the plural plant seedling pots.

### DETAILED DESCRIPTION OF THE PREFERRED EMBODIMENTS

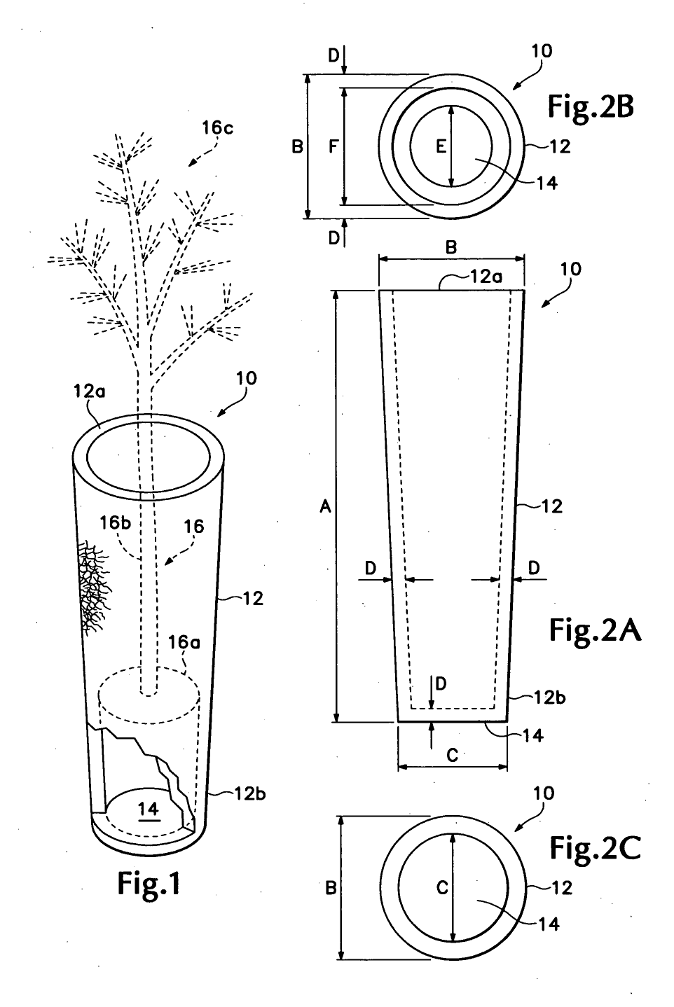

FIG. 1 is an isometric view of the plant seedling pot at 10, in accordance with one embodiment of the invention, with a partial cutaway view detailing its construction. Pot 10 may be seen to include a frusto-conical (i.e. generally circularly cross sectioned and generally linearly tapered) hollow body 12 including an upper rim region 12a and a lower base region 12b. A base 14 substantially seals base region 12b of body 12. Hollow body 12 has a nominal height and a nominal width, the ratio therebetween being greater than or equal to approximately 2:1, more preferably greater than or equal to approximately 2.5:1 and most preferably greater than or equal to approximately 3:1, as shown. The interior of hollow body 12 may be seen from FIG. 1 to be dimensioned in an interior height and an interior width that produce a capacity or volume sufficient to contain at least a substantial portion of a plant seedling (shown in phantom at 16) including a root ball (16a) and an elongate trunk (16b). Twigs and needles or other foliage (16c) of plant seedling 16 may be seen to emerge from rim region 12a of hollow body 12 and to extend upwardly and outwardly therebeyond.

In accordance with one embodiment of the invention, hollow body 12 and base 14 are integrally molded to provide a seamless, deep, tapered container for plant seedling 16. (This may be best seen in the schematically illustrated partial cutaway at the lower left base region of pot 10, wherein base 14 and hollow body 12 are seen seamlessly to join one another to form a container.) Alternatively, but within the spirit and scope of the invention, body 12 and base 14 might instead be formed separately, as by molding and/or pressing, and then joined with any suitable adhesive along a circular seam. Also in accordance with one embodiment of the invention, hollow body 12 and base 14 are made of an organic, e.g. coconut, fiber mesh having interwoven elongate filaments of various lengths and diameters, as suggested by such detail in the upper right rim region of pot 10. It will be appreciated by those of skill in the art that such coconut fiber mesh with air-filled interstices is semi-permeable at least to roots of plant seedling 16 when both are planted, thereby obviating any requirement to first remove the pot from around the seedling. It will also be appreciated that the tightly interwoven fiber mesh is of a density such that it is permeable to water and minerals while it substantially and durably contains the base of the seedling including soil that typically surrounds the root and produces the root ball.

Those of skill in the art will appreciate that the long vertical aspect and slight taper of seedling pot 10 is uniquely configured for containing, transporting, protecting, and planting plant seedlings such as tree seedlings, which tend naturally to have relatively long, straight, narrow trunks with few base twigs over a substantial portion of their length. Those of skill in the art will also appreciate that seedling pot 10 is uniquely configured for presenting plant seedlings such as tree seedlings by its unique configuration and aesthetics. Thus, tree seedlings can be given as a gift, kept at the receiver's desk or dining room table for months (with periodic watering, as may be needed) and then very simply planted with seedling and pot intact in the yard, thereby to grow a tree in antiquity.

Referring collectively to FIGS. 2A, 2B and 2C, pot 10 may be seen to be of height A, of upper width or diameter B and of lower width or diameter C. The average or nominal width or diameter (W) of pot 10 will be understood by those of skill in the art to be the average of it upper and lower widths or diameters in accordance with the formula
W_{average}=(B+C)/2 (1).
The substantially uniform thickness of the sidewalls and bottom of pot 10 may be seen from FIGS. 2A and 2B to be D. The interior base diameter of pot 10 may be seen from FIG. 2B to be E and the interior top diameter of pot 10 may be seen from FIG. 2B to be F. In accordance with one embodiment of the invention, A is approximately 6″, B is approximately 2″, C is approximately 1.6″ and D is slightly over 0.12541 (⅛″), on average, which is less than 10% of the average width Waverage of body 12. E will be understood to be approximately 1.35″ and F will be understood to be approximately 1.75″. From the great difference between A and B, in accordance with the preferred embodiment, it may be seen that the height-to-outside-diameter (or width) ratio of pot 10 is preferably greater than or equal to approximately 2:1, more preferably greater than or equal to approximately 2.5:1 and most preferably greater than or equal to approximately 3:1. Moreover, from the slight difference between B and C, in accordance with the preferred embodiment, it may be seen that the taper of body 12 over its much greater height is slight. This taper may be expressed thus:
Taper _{%}=100(B−C)/A (2).
From formula (2), the taper of the illustrated embodiment is calculated to be less than approximately 10% and may be seen more preferably to be less than approximately 6.7%.

This slender taper characteristic of pot 10 renders it uniquely useful and aesthetic.

These unique configuration attributes of vertical aspect ratio and slight taper render invented pot 10 useful for its intended purposes of containment, transportation, protection and planting and aesthetic for its intended purpose of presentation. Those of skill in the art will appreciate, however, that alternative dimensions and tapers suitable to seedling containment are contemplated as being within the spirit and scope of the invention.

Conventional pots made for transporting non-tree plants are sometimes of molded cardboard, usually square, and always characterized by a relatively shallow, wide-mouthed shape. The molding of such conventional pots is relatively straightforward because of a significantly lesser height-to-width ratio typically between 0.6 and 1.2. It is straightforward to charge such a relatively shallow, wide, conventional mold and to eject a conventional molded pot therefrom.

In stark contrast, the deep, slightly tapered pot of the present invention represents a manufacturing puzzle, the solution to which will be discussed in detail below.

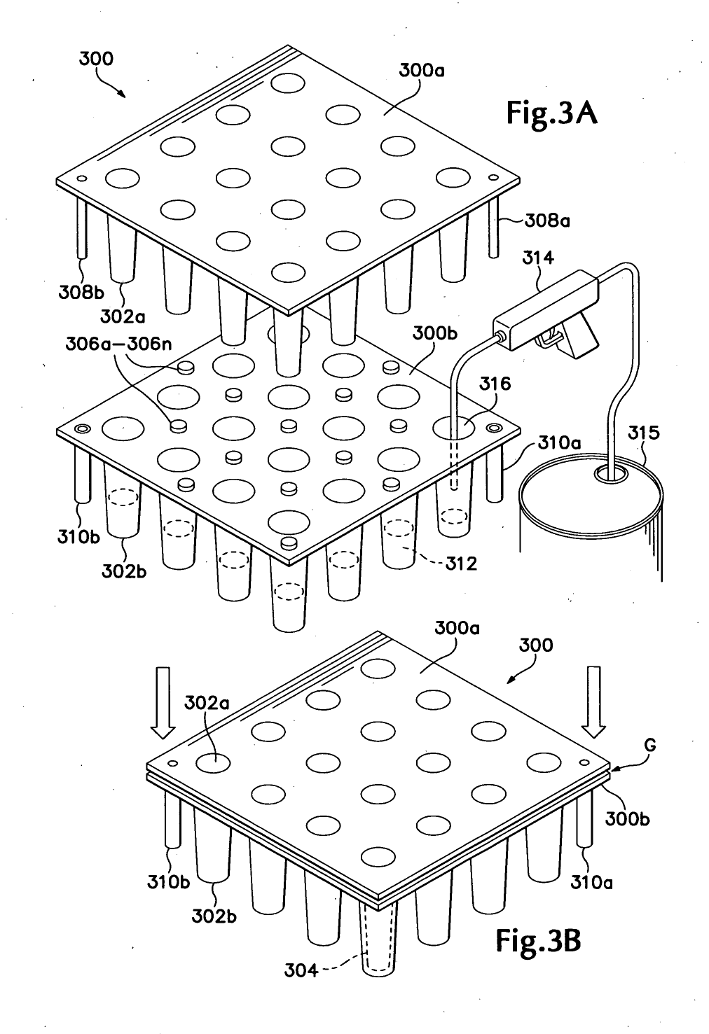

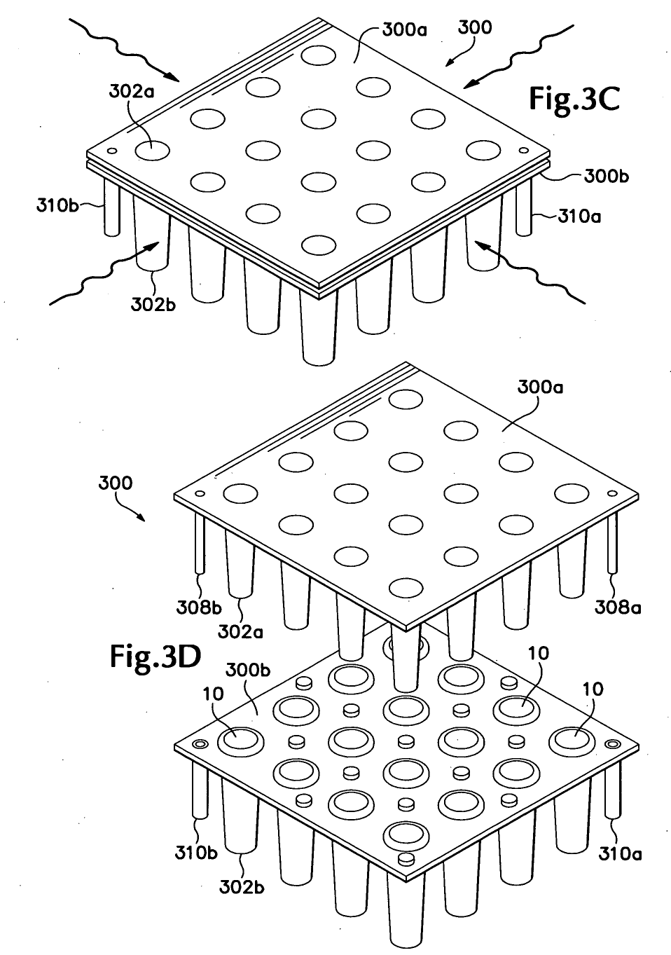

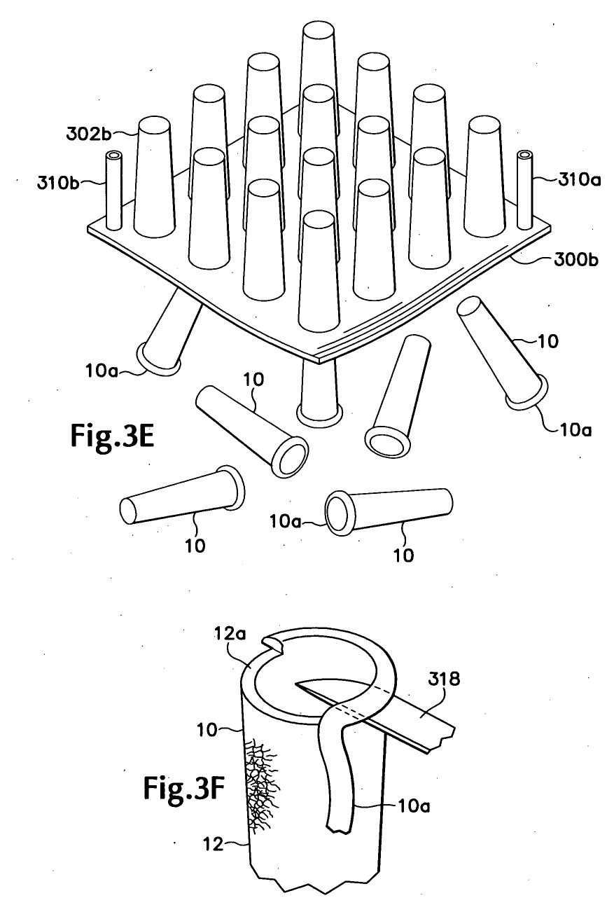

FIGS. 3A-3F are isometric views illustrating various steps of the method for manufacturing the plant seedling pot, in accordance with one embodiment of the invention. It may be seen from FIG. 3A that the method first involves providing a mold 300 in two parts 300a, 300b, the parts having mating pairs of deep, narrow recessed structures 302a, 302b height-to-width ratios that are equal to or greater than approximately 2.5:1 and preferably equal to approximately 3:1. Those of skill in the art will appreciate that, within the spirit and scope of the invention, mold parts 300a, 300b can have one or more pairs of such matable recessed structures 302a, 302b, as illustrated. In the case of plural such recesses, they are preferably regularly arrayed to produce a corresponding number of plural plant seedling pots, as will be further described below.

It may be seen from FIGS. 3A and 3B that one of the two parts, e.g. 300a, is configured to nest inside the other of the two parts, e.g. 300b, in substantial axial alignment and with a cavity or gap G (of dimension D) therebetween defined, for example, by one or more standoffs 306a-306n of height D. Those of skill in the art will appreciate that the standoffs, which may be of any suitable number n preferably regularly arrayed between the array of recessed structures, help define the nominal thickness of base 14 of plant seedling pot 10. For alignment purposes, two parts 300a, 300b of mold 300 can be equipped with one or more alignment posts 308a, 308b and one or more corresponding alignment collars 310a, 310b that ensure proper alignment of the two parts 300a, 300b of mold 300 when the two parts are pressed together. Proper alignment of two parts 300a, 300b of mold 300 promotes proper axial alignment of one or more pairs of recesses 302a, 302b and substantially uniform thickness D of the sidewalls of hollow body 12. The alignment posts and collars need engage one another for alignment purposes only as the mold pieces are pressed together and preferably before the lower ends of the upper mold piece's frusto-conical recessed structures' exterior surfaces reach the slurry, e.g. two-thirds of the way in. Those of skill in the art will appreciate that alternative alignment and gap-defining means are contemplated and that any suitable means are within the spirit and scope of the invention.

It is possible and in come cases desirable, prior to charging the cavities within the mold, to treat the inner surfaces of the mold's recesses to facilitate later release and ejection of the pots from the mold. Such an optional treatment can involve application, for example, of a thin soapy water mixture. Alternative treatments, or none at all, are contemplated, however, as being within the spirit and scope of the invention.

It may be seen from FIG. 3A that cavities 304 defined between two parts 300a, 300b of mold 300 are charged with a preferably organic fiber mesh slurry 312. Preferably, slurry 312 is a mix of coconut fiber and a binder such as rubber cement, in any suitable ratio, prepared with a suitable consistency that produces a desired cured-pot density, e.g. preferably between approximately 60% and 90% and more preferably between approximately 70% and 80%, that permits a cured pot base and/or sidewalls to be penetrated over time by root growth when a seedling contained therein is planted in the ground. The consistency of the slurry at the time of charging the mold preferably is that of a thin paste that is compressible and has a sufficiently low viscosity to enable it to flow evenly and quickly to fill each cavity in the array of cavities defined between the upper and lower mold pieces.

Those of skill in the art will appreciate that such charging can be done by hand, as by pouring, or may be at least semi-automated, as by known injection molding techniques whereby slurry material is volume-metered, for example, from a gun 314 or other apparatus and injected into each recess at a defined pressure through an opening 316 within or between either of the two parts of the mold. A slurry reservoir 315 can be used to feed gun 314 with slurry. The charging can be performed in any suitable manner that substantially fills the one or more cavities defined between the opposing and aligned recesses, under sufficient pressure to provide a desired mesh density of the sidewalls and base of one or more instances of pot 10. Preferably, in accordance with one embodiment of the invention, each cavity or recess within the lower half of the mold is charged to only a fraction, e.g. one third, of its volume, as indicated by the dashed lines of FIG. 3A. Those of skill in the art also will appreciate that the cavities may be intentionally overcharged to produce substantially seamless uniformity of thickness and density in the sidewalls and base of the one or more instances of plant seedling pot 10, so that compression of the mold pieces decreases the volume and thus increases the density of the slurry. Such an application of pressure will be described briefly below by reference to FIG. 3B.

Those of skill in the art will appreciate that, optionally, after the charging, the slurry may be compressed within mold 300 by applying inward pressure on one or more of two parts 300a, 300b of mold 300. This is indicated by downward arrows in FIG. 3B, although of course it may alternatively be achieved by upward movement or pressure on the lower mold part or a combination of upward movement of or pressure thereon and concurrent downward movement of or pressure on the upper mold part. Those of skill in the art also will appreciate that such compressing preferably is delimited by standoffs 306a-306n (hidden from view in FIG. 3B), where n=16 in accordance with one embodiment of the invention (only some of these sixteen standoffs are visible in FIG. 3A) so that the thickness of the sidewalls and base of plural instances of plant seedling pot 10 remain substantially uniform. Those of skill in the art will appreciate that more or fewer standoffs are contemplated as being within the spirit and scope of the invention. Another purpose of the standoffs is to enable the user of the mold to peer between the mold pieces through gap G to determine whether the cavities are properly charged with slurry and that there is at most only minimal overflow. Those skilled in the art will appreciate that, alternatively, the standoffs can be omitted from the mold and the thickness of the base can be determined by differential depth-wise dimensioning of the upper and lower frusto-conical mold features including the lower mold half's frusto-conical recessed-structure receptacles and the upper mold half's frusto-conical recessed-structure inserts.

FIG. 3C illustrates the curing of the one or more instances of plant seedling pot 10. Very simply, curing can be accomplished by any suitable method, including applying ambient or elevated-temperature air, i.e. heat, to molded slurry 312 within mold 300, as suggested by four wavy lines. Those of skill in the art will appreciate that the application of heat can be by exposure to the sun, a heater, etc. Those of skill in the art will appreciate that, alternatively, curing can be accomplished over a longer period of time by simply exposing the slurry-filled mold to ambient air. Any suitable curing technique that substantially dries the slurry and readies the molded plant seedling pots to be released intact from mold 300 can be used, within the spirit and scope of the invention.

FIG. 3D illustrates the separation of the two halves 300a, 300b of the mold, which typically leaves the plural plant seedling pots 10 in the lower half. Such separation can be facilitated by the application of a slight torque to the upper mold half while it is lifted from the lower mold half. Those of skill in the art will appreciate that such a torque tends to release any remnant bonds or surface adhesion between the inner surfaces of the plural plant seedling pots and the mating outer surfaces of the plural caps of the upper mold half.

Releasing one or more instances of plant seedling pot 10 from mold 300 is illustrated in FIG. 3E as involving the inversion of the lower mold half and concurrent application of a twist or torque to the part of the mold that contains the cured seedling pots (the torque being perhaps somewhat exaggerated in FIG. 3E for the sake of clarity and being highlighted by complementary pairs of curved arrows). Such torque will be understood by those of skill in the art to break any remnant bonds between the outer skin of the pots and the surfaces of the mold and also to break any surface adhesion that would otherwise inhibit intact release of the pots from the mold. Alternative techniques of releasing one or more plant seedling pots 10 from lower mold half 300b of mold 300 are contemplated, and are within the spirit and scope of the invention.

Surprisingly, it has been discovered that seedling pots characterized by a height-to-width ratio substantially greater than that of the prior art nevertheless can be molded, released and ejected intact in accordance with the present invention. Thus the invented seedling pot and method for its manufacture reap all of the benefits of aesthetic and utilitarian functionality at surprisingly low effort and cost whether in single-instance or mass production, as will be seen below.

FIG. 3E illustrates releasing/ejecting one or more plant seedling pots 10 from mold 300, as by the simple expedient of turning over the part of the mold that contains the cured and released seedling pots and, if needed, applying a slight torque or twist to the mold part, e.g. lower mold part 300b. Thus, it will be understood that releasing as used herein refers to causing the plant seedling pots to disengage from either mold piece and, for example, to be ejected as by simple gravity. It will also be understood that ejecting as used herein refers to any technique, including simple release, for causing the plant seedling pots to be removed from either mold piece. Accordingly, if required, it will be understood that one or more pots can be tugged by hand to forcibly eject them from the corresponding recess within the mold. Alternative techniques for releasing and/or ejecting one or more seedling pots 10 from mold 300 are contemplated as being within the spirit and scope of the invention.

Those of skill in the art will appreciate that, in accordance with one embodiment of the invention, one or more of the plant seedling pots 10 has a rim or shoulder 10a that extends slightly above and outwardly from the nominal top of the pot, i.e. rim region 12a (FIG. 2B). This is a result of slightly intentionally overcharging the recess 304 (FIG. 3B) to ensure proper flowing, molding and compression or densification of the organic fiber slurry. If consistent and desirable, of course, then within the spirit and scope of the invention seedling pots 10 can be molded without any overcharge, thus obviating post-mold trimming. If, on the other hand, a smooth frusto-conical exterior surface is desired, a simple trimming of rim or shoulder 10a can be performed.

Thus, it can be seen from FIG. 3F that a trimming operation optionally can be performed to regularize and smooth rim region 12a of hollow body 12 of pot 10 (shown only fragmentarily) as may be needed, typically only when the mold cavity is unintentionally overcharged. Such can be accomplished by the use of a razor-blade, box cutter, razor blade-equipped knife 318 or serrated blade-equipped coping saw mechanism by a manual technique. Alternative techniques for trimming the rim regions of pots 10, e.g. use of a power rotary or reciprocal saw or router are contemplated, and are within the spirit and scope of the invention.

Those of skill in the art will appreciate that plant seedling pot 10 is generally circular in cross section, although alternative cross-sectional configurations, e.g. an oval, a triangle, a square, a rectangle, another polygon or the like, are contemplated as being within the spirit and scope of the invention. Those of skill in the art also will appreciate that recesses 302a, 302b of mold 300 correspondingly can, within the spirit and scope of the invention, of any suitable and desirable cross-sectional shape and that the method of manufacturing one or more instances of plant seedling pot 10 is similar regardless of the chosen cross-sectional configuration.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented plant seedling pot and method for it manufacture, it will be apparent to those skilled in the art that other changes in form and detail may be made therein without departing from the spirit and scope of the invention as defined in the appended claims.

I claim:

1. A plant seedling pot comprising:
an elongate hollow body including a base region, and
a base substantially sealing the base region of the hollow body,
the hollow body having a nominal height and a nominal width, the ratio of the nominal height to the nominal width being greater than or equal to approximately 2.5:1,
an interior of the hollow body being dimensioned in an interior height and an interior width to contain at least a substantial portion of a plant seedling including a root ball and an elongate trunk.

2. The plant seedling pot of claim 1, wherein the ratio of the nominal height to the nominal width is greater than or equal to approximately 3:1.

3. The plant seedling pot of claim 2, wherein said hollow body generally uniformly tapers outwardly and upwardly from the base region over the height thereof.

4. The plant seedling pot of claim 2, wherein said hollow body and said base are integrally molded.

5. The plant seedling pot of claim 2, wherein said hollow body and said base are made of an organic fiber mesh that is semi-permeable at least to roots of a plant seedling contained in said plant seedling pot.

6. The plant seedling pot of claim 2, wherein said hollow body generally uniformly tapers outwardly and upwardly from the base region over the height thereof, wherein said hollow body and said base are integrally molded, and wherein said hollow body and said base are made of an organic fiber mesh that is semi-permeable at least to roots of a plant seedling contained in said plant seedling pot.

7. A plant seedling pot comprising:
an elongate generally circularly cross-sectioned frusto-conical hollow body including a generally circular base forming a deeply recessed container characterized by a nominal height-to-outside-diameter ratio of greater than approximately 2.5:1,
said body and said base being formed of a fabric characterized by a dense mesh of interwoven elongate organic filaments, the fabric being penetrable by roots of a seedling contained within the container when the container and seedling are planted.

8. The pot of claim 7, wherein said body and said base are integrally formed by molding.

9. The pot of claim 7, wherein said body and said base are dimensioned in an interior height and an interior width to contain at least a substantial portion of a plant seedling having a root ball and an elongate trunk.

10. The pot of claim 9, wherein each of said body and said base has a thickness that is less than approximately one-tenth of an average outside diameter of said body.

11. The pot of claim 10, wherein the nominal height-to-outside-diameter ratio of the container is greater than approximately 3:1.

12. The pot of claim 11, wherein the taper of the frusto-conical hollow body is substantially uniform over the length of the body and less than approximately 10 percent.

13. The pot of claim 12, wherein the taper of the frusto-conical hollow body is less than approximately 6.7 percent.

14. A method of manufacturing a plant seedling pot, the method comprising:
providing a mold in two parts each having a corresponding deep narrow recess the height-to-width ratio of which is greater than approximately 2.5:1, one of the two parts of the mold being configured to nest inside another;
configuring one of the two parts of the mold to nest inside the other in substantial axial alignment and with a defined gap therebetween;
charging the gap with a slurry including predetermined volumes of a binder and a coconut fiber;
curing the slurry within the mold as by drying, thereby to produce a plant seedling pot characterized by a slim taper; and
releasing the slimly tapered plant seedling pot from the mold.

15. The method of claim 14 which, after said curing step, further comprises:
trimming an upper edge of the pot, thereby to complete its manufacture.

16. The method of claim 15 which, between said charging and said curing steps, further comprises:
compressing the slurry within the mold by applying inward pressure on one or more of the two parts of the mold.

17. The method of claim 15, wherein said curing includes applying heat to the slurry within the mold.

18. The method of claim 17, wherein said charging includes pressurized injecting of the slurry into the gap between the two parts of the mold through an orifice formed within one or the other of the two parts.

19. The method of claim 15 which, prior to said charging step, further comprises:
treating one or more of the two parts of the mold to facilitate said releasing step.

20. The method of claim 19, wherein each of the two parts of the mold have plural ones of such recesses arranged in a regular array to produce plural plant seedling pots.
